(19) United States
(12) Patent Application Publication
(10) Pub. No.: US 2008/0242228 A1
(43) Pub. Date: Oct. 2, 2008

(54) RADIO COMMUNICATION APPARATUS, WIRELESS HEADPHONE AND RADIO COMMUNICATION SYSTEM

(75) Inventor: Keiji Saito, Tokyo (JP)

Correspondence Address: FOLEY AND LARDNER LLP;SUITE 500, 3000 K STREET NW, WASHINGTON, DC, 20007, US

(73) Assignee: KABUSHIKI KAISHA TOSHIBA

(21) Appl. No.: 12/053,734

(22) Filed: Mar. 24, 2008

(30) Foreign Application Priority Data
Mar. 30, 2007 (JP) 2007-090383

(51) Int. Cl. H04B 7/00

(52) U.S. Cl. 455/41.2

(57) ABSTRACT

According to one embodiment, a radio communication system has a radio communication apparatus and a wireless headphone for connecting a communication link with the radio communication apparatus to perform radio communication. The radio communication apparatus has a first radio communication device configured to connect a communication link with the wireless headphone to perform radio communication, and a transmission control unit configured to cause the first radio communication device to transmit sound data to the wireless headphone by streaming and cause the first radio communication device to transmit location information for obtaining the sound data to the wireless headphone. The wireless headphone has a second radio communication device configured to connect a communication link with the radio communication apparatus to perform radio communication, a reproduction control unit configured to perform streaming reproduction of the sound data received by the second radio communication device, and a data storage device configured to store the location information received by the second radio communication device.

### CROSS-REFERENCE TO RELATED APPLICATIONS

This application is based upon and claims the benefit of priority from Japanese Patent Application No. 2007-90383, filed Mar. 30, 2007, the entire contents of which are incorporated herein by reference.

### BACKGROUND

1. Field

One embodiment of the invention relates to a radio communication apparatus for transmitting sound data, a wireless headphone for performing streaming reproduction and a radio communication system including them.

2. Description of the Related Art

In recent years, portable music players including a function to reproduce music data stored in a memory or in a storage medium such as HDD (Hard Disk Drive) have widely gained popularity. Among them, portable music players including a radio communication module such as Bluetooth® are also developed. With a portable music player of this type, it is possible to listen to music by connecting a wireless headphone.

When listening to music using a portable music player of this type, it is becoming common that the user performs purchase or the like of music data of music to which he or she desires to listen from a web site on the Internet or the like which provides music data (such purchase of music data is also called online purchase).

Further, among web sites which provide music data, there are ones providing the user with music data for trial listening. The user can download music data for trial listening (which refers to music data with limitations in time period and/or number of times for the user to listen) from such a web site and trial listen to the music by himself or herself, or can use music data downloaded by another person such as a friend and trial listen to the music using a wireless headphone.

Then, the music data for trial listening may include information such as a URL (Uniform Resource Locator) for online purchase, and the user can use this URL to online purchase the music data of the music to which he or she has trial listened.

Incidentally, regarding trial-listening/viewing of music or video, conventionally there has been a technology related to a media trial listening/viewing service system as follows (for example, refer to Japanese Patent Application Publication (KOKAI) No. 2002-117322 (patent document 1). With this media trial listening/viewing service system, when a user connects a reproduction terminal to a distribution slave terminal placed in a shop and selects a medium of which he or she desires trial listening/viewing, the selected medium is distributed as data stream to the reproduction terminal out of media distributed from a distribution master terminal to the distribution slave terminal.

### BRIEF DESCRIPTION OF THE SEVERAL VIEWS OF THE DRAWINGS

A general architecture that implements the various features of the invention will now be described with reference to the drawings. The drawings and the associated descriptions are provided to illustrate embodiments of the invention and not to limit the scope of the invention.

FIG. 1 is an exemplary block diagram showing an overall structure of a radio communication system according to an embodiment of the invention;

FIGS. 2(a) and 2(b) are exemplary views showing examples of music related information and URLs for purchasing music data in the embodiment, in which FIG. 2(a) shows a case that the URLs are independent parameters and FIG. 2(b) shows a case that the URLs are part of music titles;

FIG. 3 is an exemplary flowchart showing an operation of a portable music reproduction apparatus in the embodiment;

FIG. 4 is an exemplary view schematically showing an overview of data transmission performed between the portable music reproduction apparatus and a wireless headphone in the embodiment;

FIG. 5 is an exemplary flowchart showing an operation of the wireless headphone in the embodiment;

FIG. 6 is an exemplary flowchart showing another operation of the portable music reproduction apparatus in the embodiment; and

FIG. 7 is an exemplary flowchart showing another operation of the wireless headphone in the embodiment.

### DETAILED DESCRIPTION

Various embodiments according to the invention will be described hereinafter with reference to the accompanying drawings. In general, according to one embodiment of the invention, a radio communication system has a radio communication apparatus and a wireless headphone for connecting a communication link with the radio communication apparatus to perform radio communication. The radio communication apparatus has a first radio communication device configured to connect a communication link with the wireless headphone to perform radio communication, and a transmission control unit configured to cause the first radio communication device to transmit sound data to the wireless headphone by streaming and cause the first radio communication device to transmit location information for obtaining the sound data to the wireless headphone. The wireless headphone has a second radio communication device configured to connect a communication link with the radio communication apparatus to perform radio communication, a reproduction control unit configured to perform streaming reproduction of the sound data received by the second radio communication device, and a data storage device configured to store the location information received by the second radio communication device.

Further, a radio communication apparatus has a radio communication device configured to connect a communication link with a wireless headphone to perform radio communication, and a transmission control unit configured to cause the radio communication device to transmit sound data to the wireless headphone by streaming and cause the radio communication device to transmit location information for obtaining the sound data to the wireless headphone.

Further, a wireless headphone has a radio communication device configured to connect a communication link with a radio communication apparatus to perform radio communication, a reproduction control unit configured to perform streaming reproduction of sound data received by the radio communication device, and a data storage device configured to store location information for obtaining the sound data received by the radio communication device.

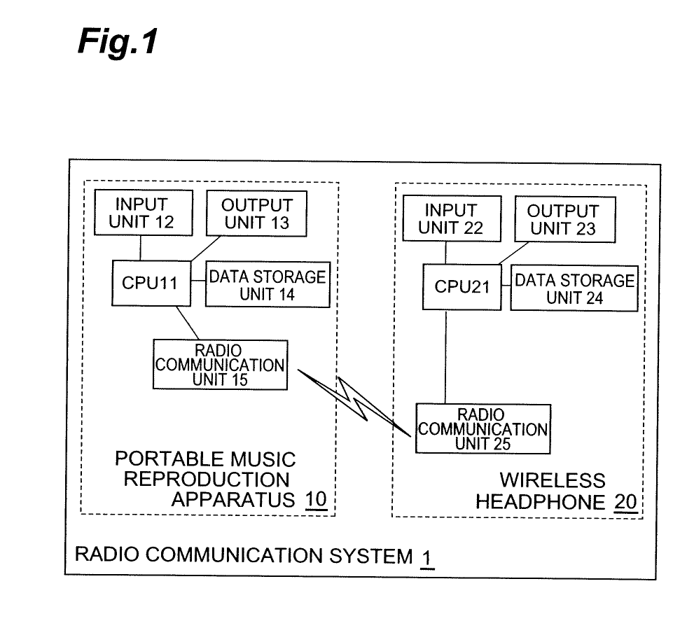

First, referring to FIG. 1, an overall structure of a radio communication system 1 according to an embodiment of the invention will be explained. FIG. 1 is a block diagram showing an overall structure of the radio communication system 1 according to the embodiment of the invention. Note that music titles and artist names that appear in this embodiment are all fictional.

The radio communication system 1 has a portable music reproduction apparatus (also referred to as a portable music player and corresponding to a radio communication apparatus) 10 and a wireless headphone 20.

The portable music reproduction apparatus 10 has a CPU (Central Processing Unit, a transmission control unit) 11, an input unit 12, an output unit 13, a data storage unit 14 and a radio communication unit (first radio communication device) 15.

The portable music reproduction apparatus 10 is, for example, a portable audio player such as an MP3 player or a mobile phone, PDA, or the like having the function of an audio player. The portable music reproduction apparatus 10 is capable of reproducing music data according to an operation by the user.

The CPU 11 is the central processing unit of the portable music reproduction apparatus 10, and controls the input unit 12, the output unit 13, the data storage unit 14 and the radio communication unit 15. The CPU 11 reproduces/decodes music data (corresponding to sound data, which will be explained later in detail) stored in the data storage unit 14 to generate a sound signal, and outputs the generated sound signal to the outside via the output unit 13.

The input unit 12 is a part where an instruction from the user or an input operation of a command is performed, and is specifically a button, a cross key, or the like. The output unit 13 is a part where a selection screen for music to be an object of reproduction or the like is presented to the user, and is specifically a liquid crystal display or the like. Further, the output unit 13 is also a part where a reproduced sound signal is outputted to the outside (not-shown headphone, speaker, or the like), and is specifically an output terminal such as a stereo mini-jack.

The data storage unit 14 is a part which stores a control program for the portable music reproduction apparatus 10 and music data (for example, WAV format data, MP3 format data, WMA format data, and the like).

Further, the data storage unit 14 stores music related information related to music such as the title of music reproduced from stored music data and the artist name thereof as well as information such as a URL or the like for online purchase of the music data. In the data storage unit 14, music data and music related information for the music data are stored in a manner that music related information are correlated with respective music data (not shown). As the data storage unit 14, for example, a flash memory or a hard disk drive (HDD: Hard Disk Drive) is used.

The radio communication unit 15 is a part which connects a communication link with the wireless headphone 20 to perform radio communication, and is specifically a module operating according to Bluetooth®, wireless LAN (Local Area Network), IrDA (Infrared Data Association), or the like. In this embodiment, it is assumed that the radio communication unit 15 operates according to Bluetooth.

Further, the radio communication unit 15 transmits to the wireless headphone 20 music data for trial listening and a URL for online purchasing the music data of the music which is trial listened (also referred to as a URL for purchasing music data). The URL for purchasing music data indicates an address of an external apparatus such as a web site or a server which provides music data, and is location information for obtaining music data.

In this case, as a profile for the radio communication unit 15 to transmit the music data for trial listening to the wireless headphone 20, there is A2DP (Advanced Audio Distribution Profile, first profile). Further, as a Bluetooth profile that can be used for the purpose of transmitting the URL for purchasing music data, there is AVRCP (Audio/Video Remote Control Profile, second profile) which will be described later. Particularly, Metadata Transfer as an extended function of the AVRCP can be used.

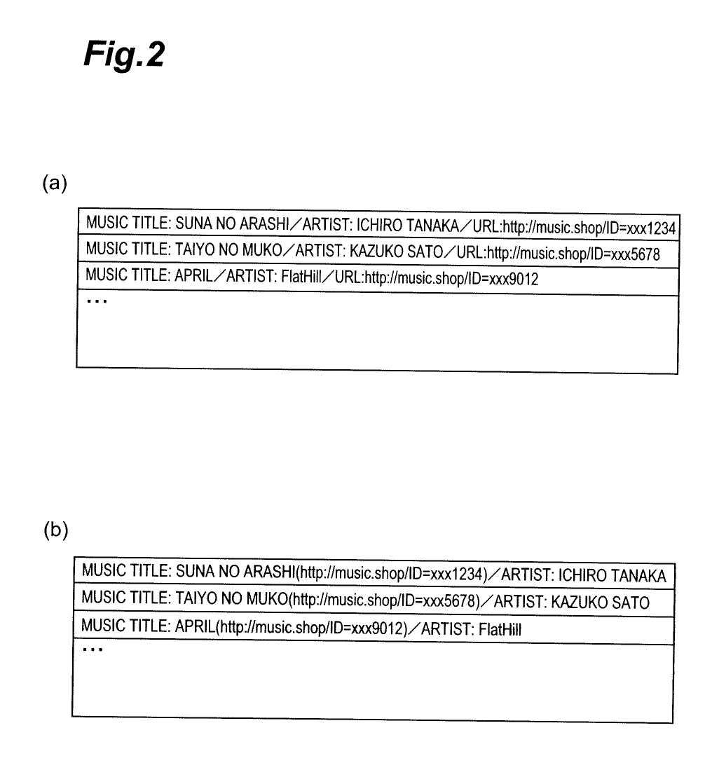

Here, the music related information and the URL for purchasing music data to be transmitted can be set such that, for example, along with a music title and an artist name as shown in FIG. 2(a), a URL is a separate parameter independent from them (for example, along with a music title: Suna no arashi and an artist name: Ichiro Tanaka, http://music.shop/ID=xxx1234 is an independent parameter as a URL for purchasing music data). In this case, the command (GET command) used for the Metadata Transfer is extended and the URL is set as a parameter independent from the music title and the artist name.

Further, as shown in FIG. 2(b), the music related information and the URL can be set such that the URL is part of a music title (for example, there are a music title: Suna no arashi (http://music.shop/ID=xxx1234) and an artist name: Ichiro Tanaka, where the URL is part of the music title). In this case, the music title and the artist name can be transmitted by an existing command, and hence the music related information and the URL can be transmitted without extending the command (GET command) used for transferring metadata. In addition, the music related information may include information such as an album title, a genre of music, a reproduction time length, and the like.

The wireless headphone 20 has a CPU 21 (reproduction control unit, storage control unit), an input unit 22, an output unit 23, a data storage unit (storage device) 24 and a radio communication unit (second radio communication device) 25. The wireless headphone 20 can perform streaming reproduction, which will be described later, using music data transmitted from the portable music reproduction apparatus 10. However, the wireless headphone 20 is not capable of saving music data transmitted from the portable music reproduction apparatus 10.

The CPU 21 is the central processing unit of the wireless headphone 20, and performs control of the input unit 22, the output unit 23, the data storage unit 24 and the radio communication unit 25. In parallel to the receiving operation of the radio communication unit 25 to receive music data, the CPU 21 performs streaming reproduction by reproducing/decoding the music data being received by the radio communication unit 25, generating a sound signal and outputting the sound from the output unit 23.

The input unit 22 is a part where an input operation is performed by the user, and is specifically a button, a switch, or the like. The output unit 23 is a part which outputs sound using a sound signal obtained by the streaming reproduction to reproduce music, and is specifically an earphone or a speaker.

The data storage unit 24 is a data storage device configured to store a control program for the wireless headphone 20 and music related information received by the radio communication unit 25, a URL and so on. The data storage unit 24 is specifically a flash memory or the like.

The radio communication unit 25 is a part which performs radio communication with the portable music reproduction apparatus 10, and is specifically a module operating according to Bluetooth or wireless LAN, IrDA, or the like. In this embodiment, it is assumed that the radio communication unit 25 operates according to Bluetooth.

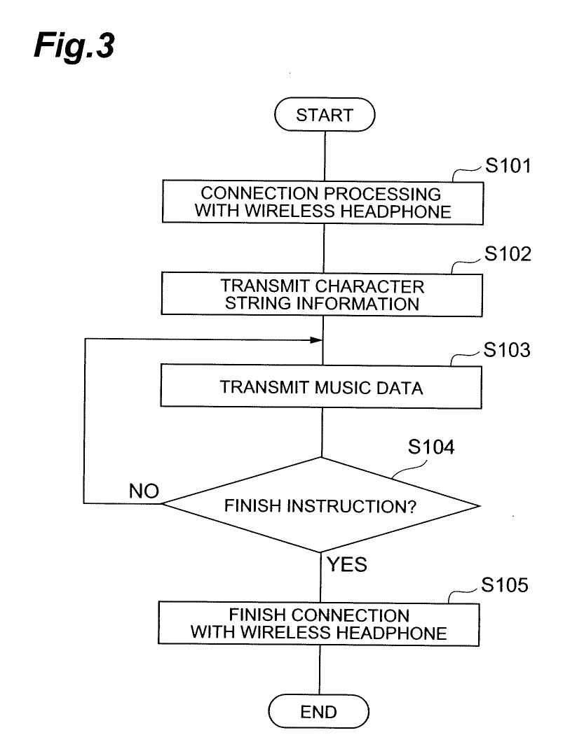

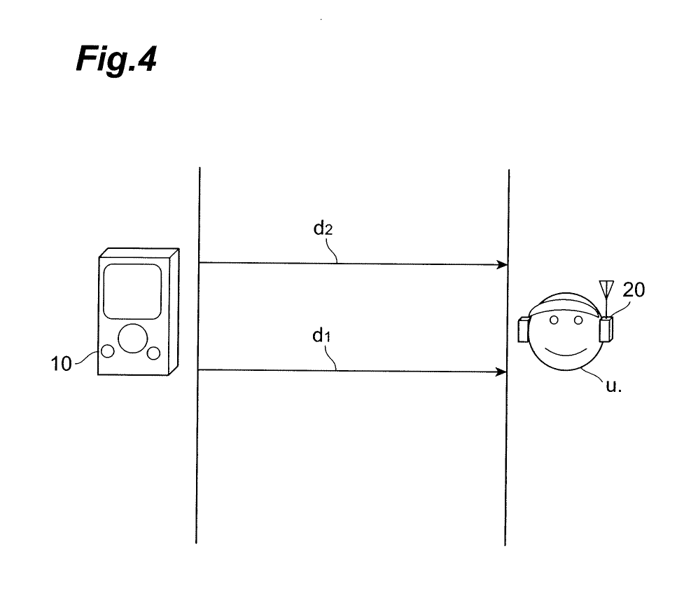

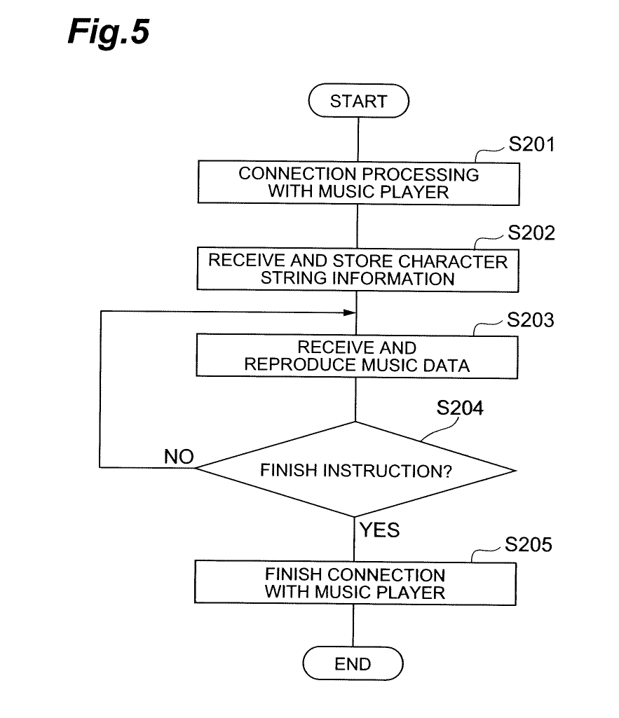

Next, with reference to FIG. 3 to FIG. 5, an operation of the radio communication system 1 according to this embodiment will be explained. FIG. 3 is a flowchart showing an operation of the portable music reproduction apparatus 10. Further, FIG. 4 is a view schematically showing an overview of data transmission performed between the portable music reproduction apparatus 10 and the wireless headphone 20 which constitute the radio communication system 1. FIG. 5 is a flowchart showing an operation of the wireless headphone 20.

Further, in this embodiment, explanations will be given with an assumption that the radio communication unit 15 of the portable music reproduction apparatus 10 and the radio communication unit 25 of the wireless headphone 20 are both a module which operates according to Bluetooth.

In an initial state, the radio communication unit 15 of the portable music reproduction apparatus 10 and the radio communication unit 25 of the wireless headphone 20 have already completed a registration operation such as exchange of capability information and exchange of link key with each other, and are able to start data communication according to A2DP and AVRCP.

First, an operation of the portable music reproduction apparatus 10 will be explained. The portable music reproduction apparatus 10 executes a connecting operation with the wireless headphone 20 by radio (S101). Specifically, between the radio communication unit 15 of the portable music reproduction apparatus 10 and the radio communication unit 25 of the wireless headphone 20, the following processing is executed in accordance with the connection procedure of Bluetooth®. Specifically, the radio communication unit 15 and the radio communication unit 25 establish a radio link via an inquiry/service search and build a logic channel, and then establish a connection of the A2DP and AVRCP profiles.

Thus, pairing is completed between the portable music reproduction apparatus 10 and the wireless headphone 20. Incidentally, the portable music reproduction apparatus 10 may be reproducing music data when performing the connection processing with the wireless headphone 20, or the portable music reproduction apparatus 10 may reproduce music data after the connection processing with the wireless headphone 20 is completed. However, a subsequent operation will not be executed in a state that music data are not reproduced.

Further, as will be described later, the connecting operation in S101 may be started from the portable music reproduction apparatus 10 side, or may be started from the wireless headphone 20 side.

In addition, the AVRCP is a profile for realizing a remote control function for audiovisual equipment, and is capable of transmitting a command such as reproduction, stop, fast forward, or the like for example. Further, here it is assumed that a function of transmitting metadata is also defined therein. In this embodiment, the portable music reproduction apparatus 10 transmits music related information and a URL for purchasing music data by the function of transferring metadata.

Subsequently, in the portable music reproduction apparatus 10, according to an instruction by the CPU 11, the radio communication unit 15 transmits music related information such as a music title, an artist name and character string information including a URL for purchasing music data to the wireless headphone 20 (S102). Here, transmission d1 of character string information shown in FIG. 4 is performed.

Next, in the portable music reproduction apparatus 10, according to an instruction by the CPU 11, the radio communication unit 15 transmits music data by streaming (S103). In this case, the CPU 11 codes the music data of reproduced music using a codec complying with the A2DP specification such as SBC, and the radio communication unit 15 transmits the coded data to the radio communication unit 25. Here, transmission d2 of music data shown in FIG. 4 is performed. In addition, the operation of S102 and the operation of S103 may be executed in parallel.

Then, in the portable music reproduction apparatus 10, the CPU 11 determines whether or not the user has given a finish instruction using the input unit 12 (S104). When the finish instruction is given, the operation is advanced to S105, which will be described later. When the finish instruction is not given, the CPU 11 returns the operation to S103. The finish instruction is given when, for example, the user stops reproduction of music data while the music data is reproduced. In S105, the CPU 11 instructs the radio communication unit 15 to finish the connection between the portable music reproduction apparatus 10 and the wireless headphone 20.

Subsequently, an operation of the wireless headphone 20 will be explained. In the wireless headphone 20, the radio communication unit 25 starts the connection processing with the portable music reproduction apparatus 10 (S201). Specifically, the radio communication unit 25 establishes a communication link upon reception of a connection request from the radio communication unit 15 of the portable music reproduction apparatus 10. Thus, pairing is completed between the portable music reproduction apparatus 10 and the wireless headphone 20. This S201 corresponds to the above-described S101. In addition, the connection request can be issued from the wireless headphone 20 side by Bluetooth®.

Next, while the radio communication unit 25 receives character string information transmitted from the portable music reproduction apparatus 10 using the Metadata Transfer, the CPU 21 operates as a storage control unit and causes the received character string information to be stored in the data storage unit 24 (S202). The S202 corresponds to the above-described S102.

Further, in the wireless headphone 20, the CPU 21 decodes sequentially the music data being received by the radio communication unit 25 to generate a sound signal in parallel to the receiving operation by the radio communication unit 25, and performs streaming reproduction of outputting the sound from the output unit 23 (S203). By this streaming reproduction being performed, the user u (refer to FIG. 4) using the wireless headphone 20 can trial listen to the music outputted from the output unit 23. The S203 corresponds to the above-described S103.

Then, in the wireless headphone 20, the CPU 21 determines whether or not the user u has given a finish instruction using the input unit 22 (S204). When the finish instruction is given, the operation is advanced to S205, which will be described later. When the finish instruction is not given, the operation is returned to S203. The finish instruction is given when, for example, the user u stops trial listening of music while he or she is trial listening to the music. In S205, the CPU 21 instructs the radio communication unit 25 to finish the connection between the wireless headphone 20 and the portable music reproduction apparatus 10.

As above, in the radio communication system 1, in advance to trial listening of music, the user u who uses the wireless headphone 20 can obtain character string information including music related information such as the music title and the artist name of the music as well as a URL for purchasing music data thereof.

The CPU 21 causes the obtained character string information to be stored in the data storage unit 24. Thus, the user u can save the obtained character string information as a file and transfer it to another apparatus such as a personal computer, a PDA (Personal Digital Assistant), and further a mobile phone, which are not shown, using the FTP (File Transfer Profile) of Bluetooth. Also, the obtained character string information can be stored in a different apparatus using a memory card such as the SD card which can be attached to/detached from the wireless headphone 20.

Therefore, with an Internet connecting environment (for example a personal computer which is connectable to the Internet) available to the user u individually, the user u of the wireless headphone 20 can connect to an external apparatus such as a web site or a server which provides music data using the URL for purchasing music data in the obtained character string information. Then, the user u can make an online purchase of the music data of music to which the user has trial listened. Thus, the radio communication system 1 is highly convenient for the user u of the wireless headphone 20.

In addition, the user u may use means different from the above-described ones when connecting to a web site using the obtained character string information.

Further, the radio communication units 15, 25 are configured to perform radio communication by Bluetooth® corresponding to the AVRCP profile. Accordingly, it is possible to perform via one connection transmission/reception of various data between the portable music reproduction apparatus 10 and the wireless headphone 20 as well as transmission of a reproduction command from the wireless headphone 20 to the portable music reproduction apparatus 10.

### Modification Example

In the above-described embodiment, it is assumed that the user u trial listens to only one piece of music per one connection between the portable music reproduction apparatus 10 and the wireless headphone 20. It is also conceivable that the user u trial listens to plural pieces of music by one connection. In this case, it is preferable that the portable music reproduction apparatus 10 transmits new character string information with a change of music being a trigger, and the wireless headphone 20 retains character string information of the respective pieces of music.

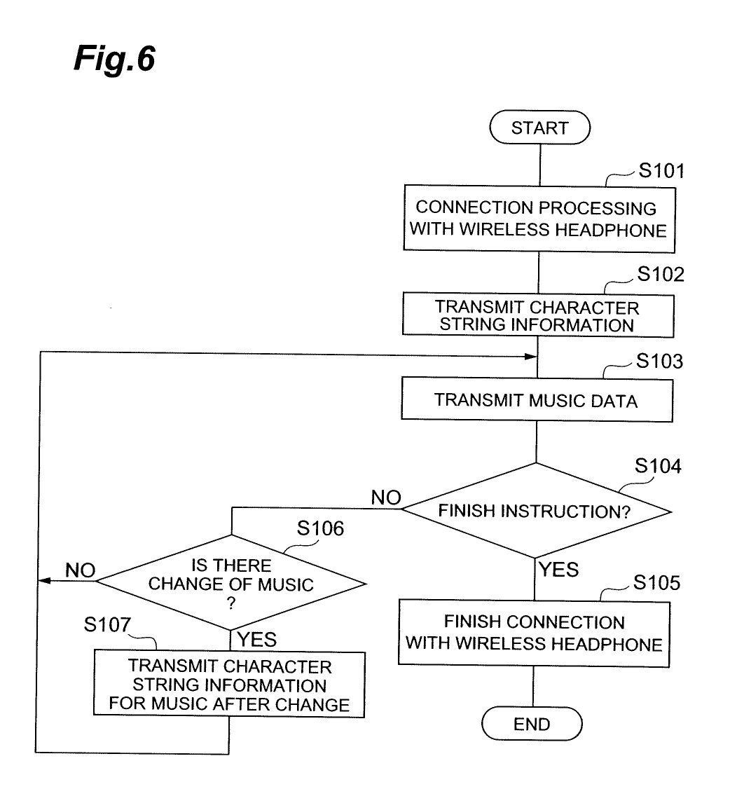

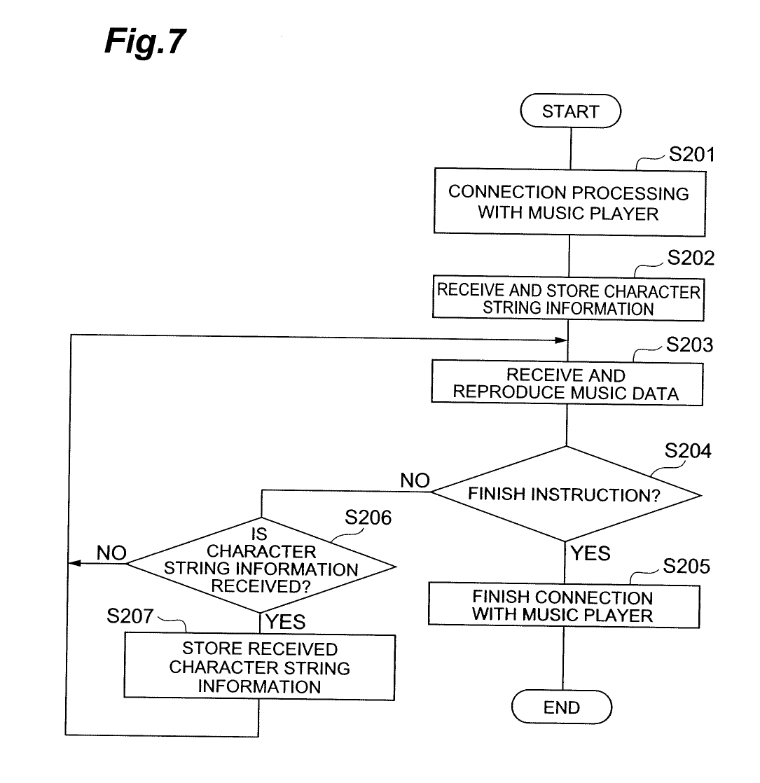

In this case, the portable music reproduction apparatus 10 and the wireless headphone 20 execute operations according to flowcharts shown in FIGS. 6, 7 respectively. Note that since the flowcharts shown in FIGS. 6, 7 are partly common with the flowcharts shown in FIGS. 3, 5 respectively, the following explanation is focused on different operations therebetween, and explanations about common operations are omitted or simplified.

The portable music reproduction apparatus 10 executes S104 after executing S101 to S103 similarly to the flowchart shown in FIG. 3. Here, when the finish instruction is given, the operation is advanced to S105. When the finish instruction is not given, the CPU 11 advances the operation to S106.

The CPU 11 determines in S106 whether there is a change of music (change of music data) or not. When there is a change of music, the CPU 11 advances the operation to S107. When there is no change of music, the operation is returned to S103. In S107, the CPU 11 instructs the radio communication unit 15 to transmit music related information and character string information including a URL for purchasing music data for the music after the change to the wireless headphone 20. After executing the operation of S107, the CPU 11 returns the operation to S103.

Next, after executing S201 to S203 similarly to the flowchart shown in FIG. 5, the wireless headphone 20 executes S204. Here, when the finish instruction is given, the operation is advanced to S205. When the finish instruction is not given, the CPU 21 advances the operation to S206.

The CPU 21 determines in S206 whether character string information is received or not. The CPU 21 advances the operation to S207 when the character string information is received. When the character string information is not received, the operation is returned to S203. In S207, the CPU 21 causes the character string information received by the radio communication unit 25 to be stored in the data storage unit 24 together with already stored character string information. Thus, every time the radio communication unit 25 receives character string information, the CPU 21 operates as a storage control unit configured to cause the character string information to be stored in the data storage unit 24. After executing the operation of S207, the CPU 21 returns the operation to S203.

Thus, when the user u of the wireless headphone 20 has trial listened to plural pieces of music by one connection, he or she is able to obtain plural URLs for online purchasing the music data of the respective pieces of music to which he or she has trial listened.

Note that the change of music can be performed by operating the input unit 101 of the portable music reproduction apparatus 10 side. In addition, the change can be realized also by transmitting from the wireless headphone 20 side “next song (FORWARD)”, “previous song (BACKWARD)”, or the like by radio, which are pass-through commands of the AVRCP.

In the above-described embodiment, the portable music reproduction apparatus 10 includes the radio communication unit 15 which performs radio communication by Bluetooth®. Besides that, the portable music reproduction apparatus 10 may be a mobile phone terminal with multiple functions, a PDA, or the like.

Further, the wireless headphone 20 is an apparatus which performs radio communication by Bluetooth®, and is configured to support as a profile the A2DP, the AVRCP and the Metadata Transfer that is an extended function thereof. Both of the portable music reproduction apparatus 10 and the wireless headphone 20 perform radio communication according to Bluetooth®, but they may perform radio communication according to a wireless LAN or an IrDA module.

The above explanation is for explaining the embodiment of the invention and does not limit the apparatus and the method of the invention, and various modification examples thereof can be implemented easily. Further, an apparatus or a method formed by appropriately combining the components, functions, features or method steps in each embodiment is also included in the invention.

While certain embodiments of the inventions have been described, these embodiments have been presented by way of example only, and are not intended to limit the scope of the inventions. Indeed, the novel methods and systems described herein may be embodied in a variety of other forms; furthermore, various omissions, substitutions and changes in the form of the methods and systems described herein may be made without departing from the spirit of the inventions. The accompanying claims and their equivalents are intended to cover such forms or modifications as would fall within the scope and spirit of the inventions.

What is claimed is:

1. A radio communication system comprising a radio communication apparatus and a wireless headphone for connecting a communication link with said radio communication apparatus to perform radio communication,
said radio communication apparatus having:
a first radio communication device configured to connect a communication link with said wireless headphone to perform radio communication; and
a transmission control unit configured to cause said first radio communication device to transmit sound data to said wireless headphone by streaming and cause said first radio communication device to transmit location information for obtaining the sound data to said wireless headphone, and
said wireless headphone having:
a second radio communication device configured to connect a communication link with said radio communication apparatus to perform radio communication;
a reproduction control unit configured to perform streaming reproduction of the sound data received by said second radio communication device; and
a data storage device configured to store the location information received by said second radio communication device.

2. A radio communication apparatus, comprising:
a radio communication device configured to connect a communication link with a wireless headphone to perform radio communication; and
a transmission control unit configured to cause said radio communication device to transmit sound data to said wireless headphone by streaming and cause said radio communication device to transmit location information for obtaining the sound data to said wireless headphone.

3. The radio communication apparatus according to claim 2, wherein said transmission control unit is configured to cause the location information to be transmitted to said radio communication device together with related information related to the sound data.

4. The radio communication apparatus according to claim 2, wherein said transmission control unit is configured to cause, when there is a change of the sound data transmitted by said radio communication device by streaming, said radio communication device to transmit location information for obtaining the changed sound data to said wireless headphone.

5. The radio communication apparatus according to claim 3, wherein said transmission control unit is configured to cause the sound data to be transmitted via radio communication by a first profile, and cause the related information and the location information to be transmitted via radio communication by a second profile.

6. The radio communication apparatus according to claim 2,
wherein said radio communication device is configured to perform Bluetooth® communication by AVRCP (Audio/Video Remote Control Profile), and wherein said transmission control unit is configured to cause location information for obtaining the sound data to be transmitted via the Bluetooth communication by the AVRCP.

7. A wireless headphone, comprising:
a radio communication device configured to connect a communication link with a radio communication apparatus to perform radio communication;
a reproduction control unit configured to perform streaming reproduction of sound data received by said radio communication device; and
a data storage device configured to store location information for obtaining the sound data received by said radio communication device.

8. The wireless headphone according to claim 7, further comprising a storage control unit configured to cause, every time said radio communication device receives the location information, the location information received by said radio communication device to be stored in said data storage device.

9. The wireless headphone according to claim 7, wherein said radio communication device is configured to perform Bluetooth® communication by AVRCP (Audio/Video Remote Control Profile), and receive the location information via the Bluetooth communication by the AVRCP.
